(19) United States
(12) Patent Application Publication
(10) Pub. No.: US 2025/0380636 A1
(43) Pub. Date: Dec. 18, 2025

(54) TRANSMISSION UNIT AND LAWN MOWER

(71) Applicants: KAWASAKI MOTORS, LTD., Hyogo (JP); Shin Nippon Wheel Industries Co., Ltd, Hamamatsu-shi (JP)

(72) Inventors: Ryota MOCHIZUKI, Akashi-shi (JP); Mitsuyoshi TERADA, Hamamatsu-shi (JP); Yoshiyuki IWATANI, Hamamatsu-shi (JP)

(21) Appl. No.: 18/743,777

(22) Filed: Jun. 14, 2024

(51) Int. Cl. A01D 34/76; A01D 34/64; A01D 101/00

(52) U.S. Cl. CPC A01D 34/76; A01D 34/64; A01D 2101/00

(57) ABSTRACT

A transmission unit includes an input shaft to which motive power from a drive source is input, an output shaft, first and second gear trains provided between the input shaft and the output shaft, first and second clutches that respectively switch the first and second gear trains to a power transmission state or a non-power transmission state, and a transmission case. When the drive source is switched between first and second rotation speeds, the output shaft is rotationally driven at a predetermined rotation speed. Each of the first and second clutches is a hydraulic clutch. A hydraulic circuit that supplies hydraulic pressure to hydraulic chambers of the first and second clutches is formed in the transmission case.

### BACKGROUND

### Technical Field

The present disclosure relates to a transmission unit and a lawn mower.

### Background Art

U.S. Unexamined Patent Application Publication No. 2019/0029172 discloses a riding-type work machine that drives a lawn mowing mechanism using an engine.

### SUMMARY

In a lawn mower as a riding-type work machine, when the rotation of an engine is transmitted to a mowing-blade through a transmission unit, the engine speed may be kept constant to maintain the mowing-blade rotation speed in order to secure output characteristics such as lawn mowing quality. In such a transmission unit, there is room for improvement in suppressing fuel consumption while securing output performance. The transmission unit is also desired to be integrated with the transmission case to improve assemblability.

An object of the present disclosure is to provide a transmission unit and a lawn mower capable of suppressing fuel consumption while securing output performance and integrating the transmission unit with a transmission case with excellent assemblability.

In order to achieve the above object, the present disclosure provides a transmission unit including: an input shaft to which motive power from a drive source is input; an output shaft configured to output the motive power from the drive source; a first gear train and a second gear train provided between the input shaft and the output shaft; a first clutch and a second clutch configured to respectively switch the first gear train and the second gear train to a power transmission state or a non-power transmission state; and a transmission case configured to house the input shaft, the output shaft, the first gear train, the second gear train, the first clutch, and the second clutch, in which when the drive source is switched between a first rotation speed and a second rotation speed lower than the first rotation speed, the power transmission states of the first clutch and the second clutch are switched, so that the output shaft is rotationally driven at a predetermined rotation speed, in which each of the first clutch and the second clutch is a hydraulic clutch, and in which a hydraulic circuit that supplies hydraulic pressure to hydraulic chambers of the first clutch and the second clutch is formed in a transmission case.

According to the present disclosure, in the transmission unit, even when the drive source is switched between the first rotation speed and the second rotation speed, the output shaft is rotationally driven at a predetermined rotation speed by switching the power transmission state of the first clutch and the second clutch. Accordingly, even when the drive source is rotationally driven at the second rotation speed that is lower than the first rotation speed, the output shaft can be rotationally driven at the predetermined rotation speed, and fuel consumption can be suppressed while securing output performance. In the transmission unit, since the hydraulic circuit that supplies hydraulic pressure to the hydraulic chambers of the first clutch and the second clutch is formed in the transmission case, the transmission unit can be integrated with the transmission case with good assemblability. Therefore, the transmission unit can suppress the fuel consumption while securing the output performance, and can be integrated with the transmission case with good assemblability.

The present disclosure also provides a lawn mower including: a drive source; a mowing-blade rotationally driven by motive power from the drive source; and the transmission unit configured to shift motive power from the drive source and output the motive power to the mowing-blade.

According to the present disclosure, in the lawn mower including the drive source, the mowing-blade, and the transmission unit, the transmission unit that can be integrated with the transmission case with good assemblability is disposed between the drive source and the mowing-blade, and when a load on the mowing-blade rotationally driven by the drive source is small, even when the drive source is rotationally driven at the second rotation speed lower than the first rotation speed, the mowing-blade can be rotationally driven at a predetermined rotation speed, and it is possible to suppress fuel consumption while securing lawn mowing quality.

### BRIEF DESCRIPTION OF DRAWINGS

The foregoing and the other features of the present disclosure will become apparent from the following description and drawings of an illustrative embodiment of the disclosure in which:

FIG. 1 is a schematic side view of a lawn mower;

FIG. 2 is a schematic view of a transmission unit to which an engine and a pulley are attached;

FIG. 3 is a perspective view of the transmission unit;

FIG. 4 is a schematic cross-sectional view of the transmission unit;

FIG. 5 is a plan view of the transmission unit excluding the upper case;

FIG. 6 is a plan view of the transmission unit excluding the upper case and the transmission mechanism;

FIG. 7 is a diagram showing a hydraulic circuit of the transmission unit; and

FIG. 8 is a control block diagram of a lawn mower.

### DETAILED DESCRIPTION

Hereinafter, a lawn mower including a transmission unit according to an embodiment of the present disclosure will be described with reference to the accompanying drawings.

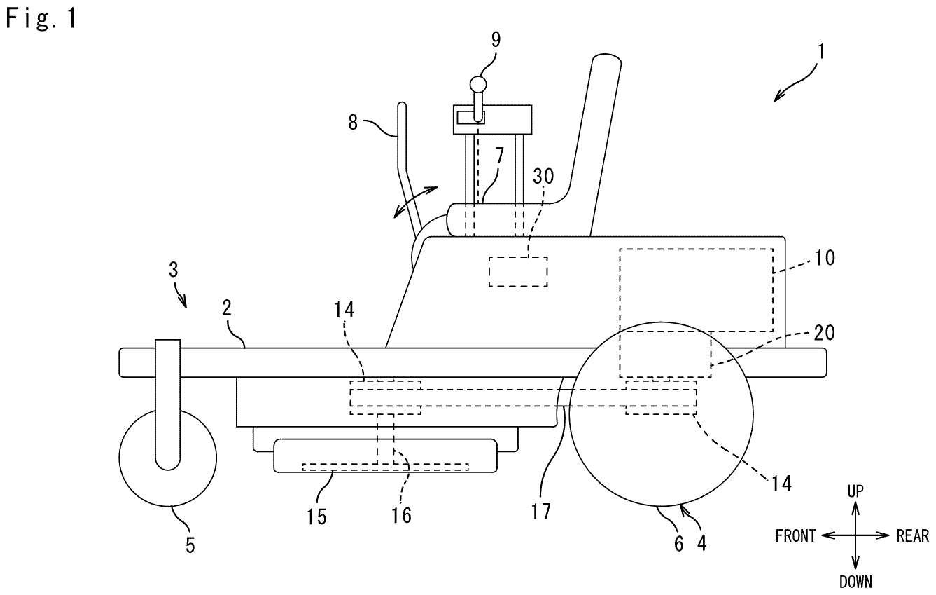

FIG. 1 is a schematic side view of a lawn mower according to an embodiment of the present disclosure. The lawn mower 1 shown in FIG. 1 is a riding-type work machine that a driver rides on and operates. It should be noted that, in the present specification, “front”, “rear”, “left”, and “right” refer to a front direction, a rear direction, a left direction, and a right direction as viewed from a driver riding on the lawn mower 1.

The lawn mower 1 includes a vehicle main body 3 having a vehicle body frame 2 extending in the front-rear direction. The vehicle main body 3 includes wheels 4 at each of the front portion and the rear portion of the vehicle body frame 2. The wheels 4 include left and right front wheels 5 and left and right rear wheels 6.

In the lawn mower 1, an engine 10 as a drive source is mounted between the left and right rear wheels 6. The engine 10 is not limited thereto, but is an engine including a fuel injection device. The engine 10 rotationally drives the left and right rear wheels 6, which are traveling drive wheels, and rotationally drives the lawn mowing-blade 15. The engine 10 functions as a traveling drive source and a mowing-blade drive source. The engine 10 is configured so that the output increases as the rotation speed increases in a predetermined rotation region such as an engine speed of 1500 to 3600 rpm.

The motive power from the engine 10 is transmitted to the rear wheels 6 through a power transmission mechanism (not shown). The power transmission mechanism includes an oil pump and a hydraulic motor. The power transmission mechanism is configured to activate the hydraulic motor with high-pressure oil from the oil pump mechanically connected to the engine 10 to drive the rear wheels 6 connected to the hydraulic motor.

The motive power from the engine 10 is also transmitted to the mowing-blade 15 through the transmission unit 20. The transmission unit 20 is configured to shift the motive power from the engine 10 and output the motive power to the mowing-blade 15.

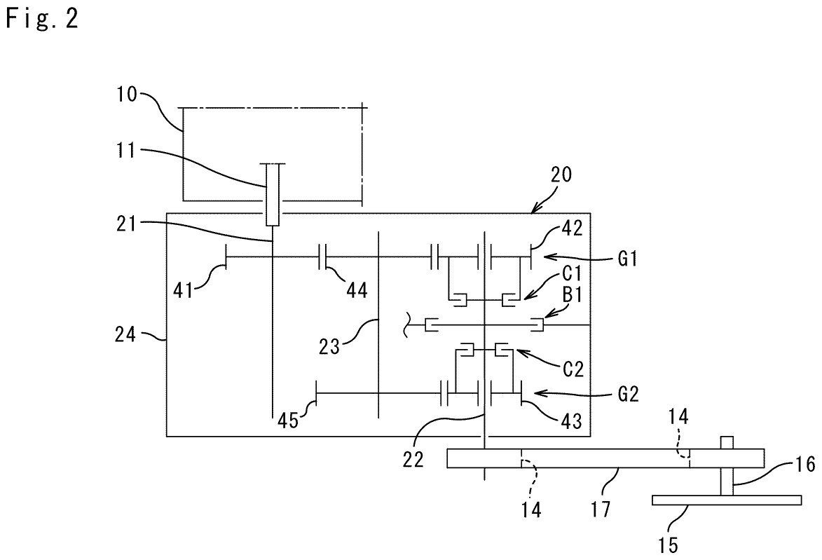

FIG. 2 is a schematic view of a transmission unit to which an engine and a pulley are attached. As shown in FIG. 2, the transmission unit 20 includes an input shaft 21 mechanically connected to an output shaft 11 of the engine 10, and an output shaft 22 connected to a rotation shaft 16 of the mowing-blade 15 using a pulley 14 and a power transmission belt 17. In the transmission unit 20, motive power from the engine 10 is input to the input shaft 21, and is output to the mowing-blade 15 from the output shaft 22 through the power transmission belt 17. In the power transmission belt 17, the ratio of the rotation speed of the output shaft 22 to the mowing-blade rotation speed is set to 1 using the pulley 14, but may be set to be larger or smaller than 1.

As shown in FIG. 1, the transmission unit 20 is supported by the vehicle body frame 2. The mowing-blade 15 is rotatably supported by the vehicle body frame 2 below the vehicle body frame 2. The engine 10 and the transmission unit 20 are disposed between the left and right rear wheels 6. The engine 10 is coupled to the upper side of the transmission unit 20 so that the output shaft 11 of the engine 10 extends in the vertical direction.

The lawn mower 1 includes an operation seat 7 on which the driver sits and operates. The operation seat 7 is disposed between the front wheels 5 and the rear wheels 6. In front of the operation seat 7, a traveling lever 8 for operating the traveling of the lawn mower 1 is disposed. The traveling lever 8 is mechanically connected to the oil pump for traveling mechanically connected to the engine 10. The oil pump is operated according to the operation of the traveling lever 8, and the lawn mower 1 travels.

An output lever 9 with which an engine output can be selectively input by the driver is provided on a side of the operation seat 7. The output lever 9 is configured so that the lever position is selectively movable. The engine output is controlled so that the engine speed changes according to the lever displacement position of the output lever 9.

The output lever 9 is configured to be selectively input from a high engine output position at which the engine speed is set to a first rotation speed R1 and a low engine output position at which the engine speed is set to a second rotation speed R2 lower than the first rotation speed R1. The output lever 9 is moved from a mowing-blade stop position, which is an initial position at which the engine speed is set to a third rotation speed R3 lower than the second rotation speed R2, and at which the rotation of the mowing-blade 15 is stopped, to the high engine output position or the low engine output position. The output lever 9 is held at the mowing-blade stop position during non-work such as non-mowing, is moved to the high engine output position during high-load work with a large mowing load, and is moved to the low engine output position during low-load work with a small mowing load.

In the lawn mower 1, as described below, even when the engine 10 is rotationally driven at the second rotation speed R2 that is lower than the first rotation speed R1, the rotation speed of the mowing-blade 15 is driven at a predetermined rotation speed. The predetermined rotation speed is substantially constant, and the rotation speed difference is preferably set to 100 rpm or less. Accordingly, when a mowing load is small, for example, it is possible to suppress fuel consumption while securing the lawn mowing quality.

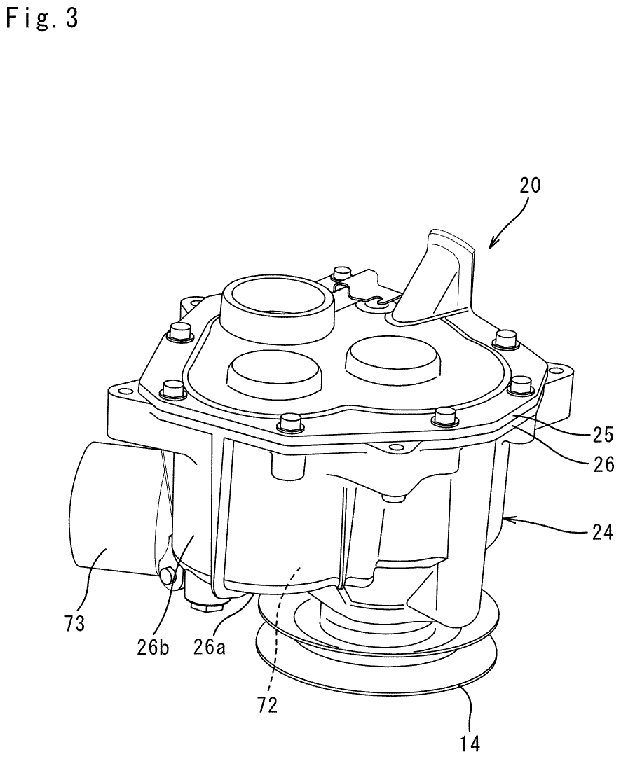

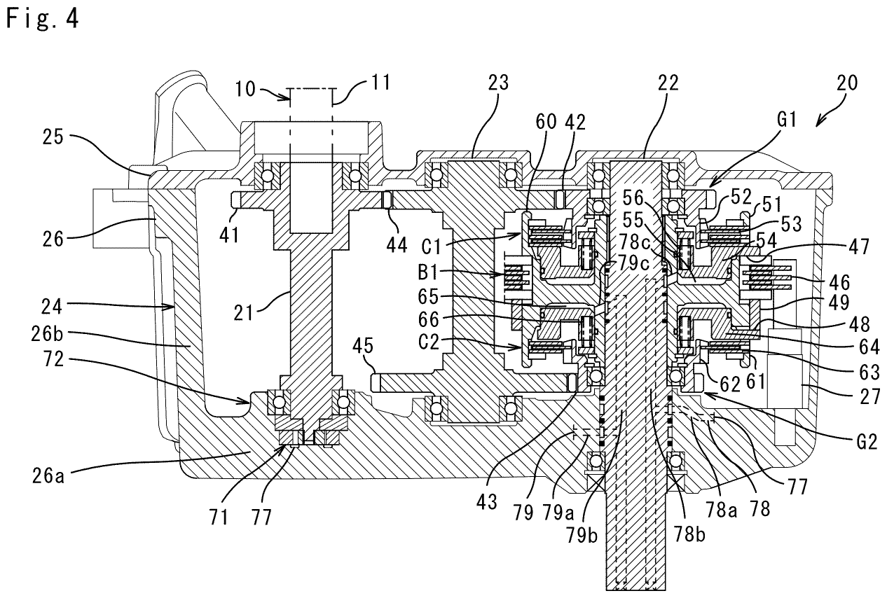

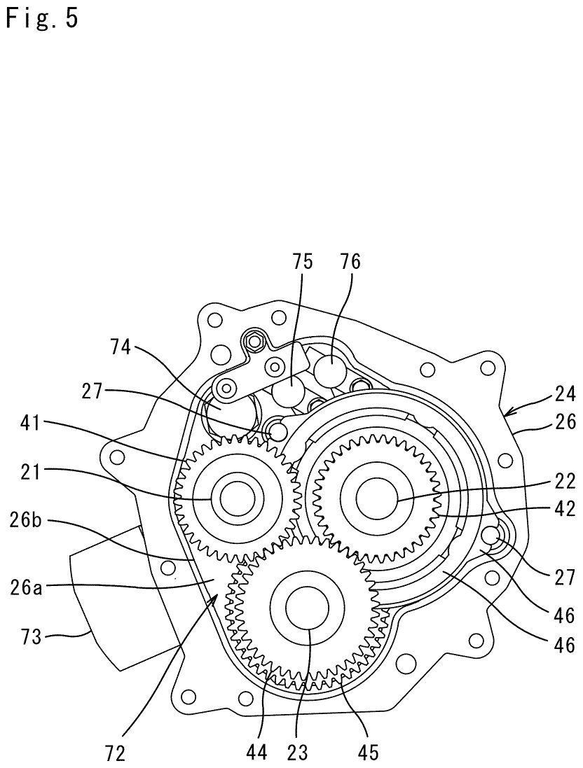

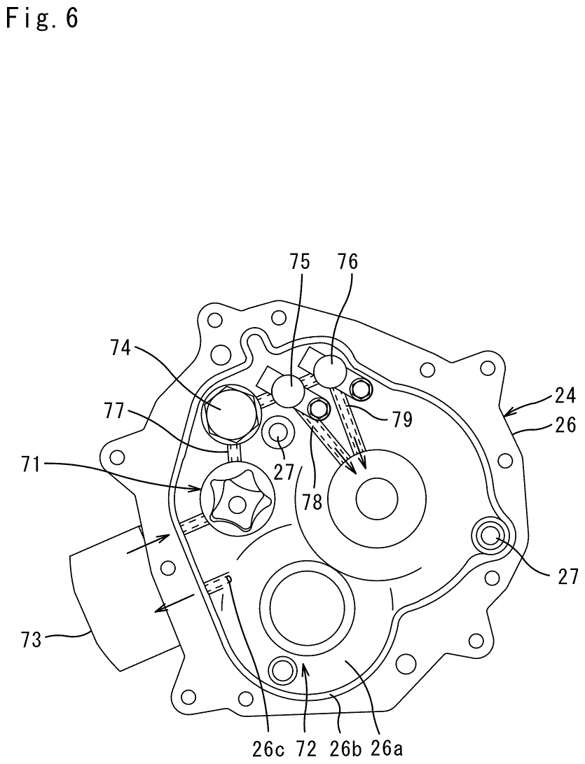

FIG. 3 is a perspective view of the transmission unit. FIG. 4 is a schematic cross-sectional view of the transmission unit. FIG. 5 is a plan view of the transmission unit excluding the upper case. FIG. 6 is a plan view of the transmission unit excluding the upper case and the transmission mechanism.

As shown in FIG. 4, the transmission unit 20 includes an input shaft 21 to which motive power from the engine 10 is input, an output shaft 22 that is disposed in parallel with the input shaft 21 and outputs the motive power from the engine 10 input to the input shaft 21, and an intermediate shaft 23 disposed in parallel with the input shaft 21 and the output shaft 22. Each of the input shaft 21, the output shaft 22, and the intermediate shaft 23 extends in the vertical direction and is rotatably supported by the transmission case 24.

The input shaft 21 is fixedly provided with a drive gear 41. A first driven gear 42 and a second driven gear 43 are rotatably supported by the output shaft 22. The first driven gear 42 is disposed above the second driven gear 43. The intermediate shaft 23 is fixedly provided with a first intermediate gear 44 and a second intermediate gear 45. The first intermediate gear 44 is disposed above the second intermediate gear 45. The first intermediate gear 44 meshes with the drive gear 41 and meshes with the first driven gear 42. The second intermediate gear 45 meshes with the second driven gear 43.

A first gear train G1 and a second gear train G2 are provided between the input shaft 21 and the output shaft 22. The first gear train G1 includes a drive gear 41, a first intermediate gear 44, and a first driven gear 42. The second gear train G2 includes a drive gear 41, a second intermediate gear 45, and a second driven gear 43. The first gear train G1 is disposed above the second gear train G2. The drive gear 41 is shared by the first gear train G1 and the second gear train G2, and the first intermediate gear 44 and the first driven gear 42 of the first gear train G1 are disposed above the second intermediate gear 45 and the second driven gear 43 of the second gear train G2.

The first intermediate gear 44 has a smaller gear diameter and a smaller number of teeth than the second intermediate gear 45. The first driven gear 42 has a larger gear diameter and a larger number of teeth than the second driven gear 43. The second gear train G2 is set to have a reduction ratio smaller than that of the first gear train G1. The reduction ratio, that is, the transmission ratio is a ratio of the rotation speed of the input shaft 21 to the rotation speed of the output shaft 22. The reduction ratio of the first gear train G1 is a product of a ratio of the number of teeth of the first intermediate gear 44 to the number of teeth of the drive gear 41 and a ratio of the number of teeth of the first driven gear 42 to the number of teeth of the first intermediate gear 44. The reduction ratio of the second gear train G2 is a product of a ratio of the number of teeth of the first intermediate gear 44 to the number of teeth of the drive gear 41 and a ratio of the number of teeth of the second driven gear 43 to the number of teeth of the second intermediate gear 45. In the transmission unit 20, the reduction ratio of the first gear train G1 is set to 1, and the reduction ratio of the second gear train G2 is set to 0.73, but the present disclosure is not limited thereto.

The transmission unit 20 includes a first clutch C1 and a second clutch C2 that switch the first gear train G1 and the second gear train G2 to the power transmission state or the non-power transmission state, respectively. When the engine 10 is switched between the first rotation speed R1 and the second rotation speed R2 lower than the first rotation speed R1, the power transmission states of the first clutch C1 and the second clutch C2 are switched, so that the output shaft 22 is rotationally driven at a substantially constant predetermined rotation speed. As the first clutch C1 and the second clutch C2, a hydraulic clutch is used.

The first clutch C1 includes a clutch drum 51, a clutch hub 52, a plurality of friction plates 53, a piston 54, and a hydraulic chamber 55. The clutch drum 51 is spline-engaged with the output shaft 22. The clutch hub 52 is coupled to the first driven gear 42. The plurality of friction plates 53 are alternately engaged with the clutch drum 51 and the clutch hub 52 and arranged side by side in the shaft direction. The piston 54 is configured to press the plurality of friction plates 53. The hydraulic chamber 55 is supplied with oil that biases the piston 54 in the direction of the friction plate. On the opposite side of the hydraulic chamber 55 across the piston 54, a return spring 56 that biases the piston 54 in the anti-friction plate direction is disposed.

In the first clutch C1, when the hydraulic pressure by oil is supplied to the hydraulic chamber 55, the piston 54 presses and fastens the friction plate 53 to bring the first gear train G1 into a power transmission state. When the hydraulic pressure by oil is discharged from the hydraulic chamber 55, the first clutch C1 is released to bring the first gear train G1 into the non-power transmission state.

The second clutch C2 includes a clutch drum 61, a clutch hub 62, a plurality of friction plates 63, a piston 64, and a hydraulic chamber 65. The clutch drum 61 is spline-engaged with the output shaft 22. The clutch hub 62 is coupled to the second driven gear 43. The plurality of friction plates 63 are alternately engaged with the clutch drum 61 and the clutch hub 62 and arranged side by side in the shaft direction. The piston 64 is configured to press the plurality of friction plates 63. The hydraulic chamber 65 is supplied with oil that biases the piston 64 in the direction of the friction plate. On the opposite side of the hydraulic chamber 65 across the piston 64, a return spring 66 that biases the piston 64 in the anti-friction plate direction is disposed.

In the second clutch C2, when the hydraulic pressure by oil is supplied to the hydraulic chamber 65, the piston 64 presses and fastens the friction plate 63 to bring the second gear train G2 into a power transmission state. When the hydraulic pressure by oil is discharged from the hydraulic chamber 65, the second clutch C2 is released to bring the second gear train G2 into the non-power transmission state. The clutch drum 51 of the first clutch C1 and the clutch drum 61 of the second clutch C2 are integrally formed by the drum housing 60 spline-engaged with the output shaft 22.

The transmission unit 20 includes a brake B1 that fixes the output shaft 22 to the transmission case 24 when the first clutch C1 and the second clutch C2 respectively bring the first gear train G1 and the second gear train G2 into the non-power transmission state.

The brake B1 includes a plurality of friction plates 46, a first clamping portion 47, and a second clamping portion 48. The plurality of friction plates 46 are alternately engaged with the fixing pin 27 fixed to the transmission case 24 and the drum housing 60 and arranged side by side in the shaft direction. The first clamping portion 47 and the second clamping portion 48 clamp the plurality of friction plates 46. The first clamping portion 47 is formed by the piston 54 of the first clutch C1. The second clamping portion 48 is formed by the piston 64 of the second clutch C2, and clamps the friction plate 46 through the sleeve 49 movably fitted in the shaft direction to the drum housing 60.

In the brake B1, when the hydraulic pressure is discharged from the hydraulic chambers 55 and 65 of the first clutch C1 and the second clutch C2, the first clamping portion 47 and the second clamping portion 48 press and fasten the plurality of friction plates 46, thereby fixing the output shaft 22 to the transmission case 24. The brake B1 is released when the hydraulic pressure is supplied to the hydraulic chambers 55 and 65 of any one of the first clutch C1 and the second clutch C2. Supply and discharge of the hydraulic pressure to and from the hydraulic chambers 55 and 65 of the first clutch C1 and the second clutch C2 are controlled by the controller 30.

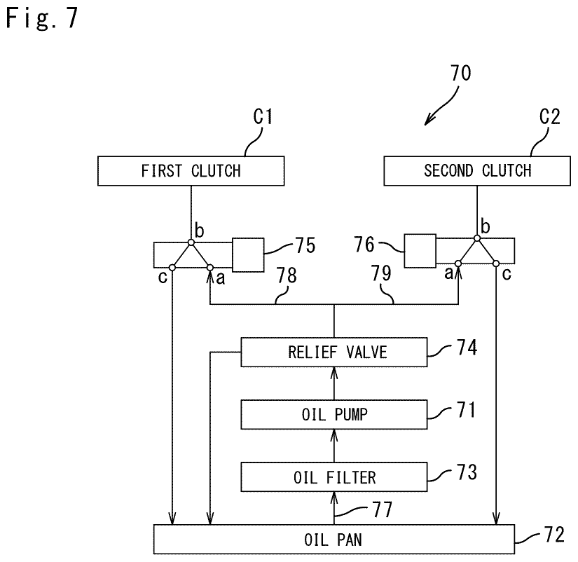

FIG. 7 is a diagram showing a hydraulic circuit of the transmission unit. As shown in FIG. 7, the hydraulic circuit 70 that supplies hydraulic pressure to the hydraulic chambers 55 and 65 of the first clutch C1 and the second clutch C2 selectively supplies hydraulic pressure from the oil pump 71 to the hydraulic chambers 55 and 65 of the first clutch C1 and the second clutch C2 to transmit motive power from the engine 10 to the mowing-blade 15.

The oil pump 71 is attached to a lower portion of the input shaft 21. To an upper portion of the input shaft 21, an output shaft 11 of the engine 10 is spline-fitted. The oil pump 71 is driven by the engine 10 to generate hydraulic pressure. As the oil pump 71, a trochoid pump is used, but other pumps may be used.

When the oil pump 71 operates, the hydraulic circuit 70 sucks oil from the oil pan 72 and supplies the oil to the first clutch C1 or the second clutch C2 through the oil filter 73, the oil pump 71, the relief valve 74, the first solenoid valve 75, or the second solenoid valve 76. The relief valve 74 sets the oil to a substantially constant pressure to supply the oil to the first and second solenoid valves 75 and 76.

As the solenoid valves 75 and 76, linear solenoid valves are used. The solenoid valves 75 and 76 are configured to operate so as to control the hydraulic pressure input to the original pressure port a to the hydraulic pressure to be supplied to the hydraulic chambers 55 and 65 of the clutches C1 and C2 and output the hydraulic pressure to the output port b, or to cut off between the original pressure port a and the output port b and allow the output port b to communicate with the drain port c, and supply and discharge the hydraulic pressure to and from the hydraulic chambers 55 and 65 of the clutches C1 and C2, respectively. The first and second solenoid valves 75 and 76 function as hydraulic control valves that control the hydraulic pressure supplied to the first and second clutches C1 and C2, respectively. The first and second solenoid valves 75 and 76 are controlled by the controller 30. The solenoid valves 75 and 76 are preferably configured to communicate the original pressure port a and the output port b to fasten the clutches C1 and C2 when energized, communicate the output port b and the drain port c to release the clutches C1 and C2 when de-energized, and fasten the brake B1 when the first and second solenoid valves 75 and 76 are de-energized.

The hydraulic circuit 70 is formed in the transmission case 24. As shown in FIG. 3, the transmission case 24 is formed by coupling a substantially flat plate-shaped upper case 25 disposed on the upper side and a substantially bottomed cylindrical lower case 26 disposed on the lower side.

As shown in FIGS. 4 and 5, the input shaft 21, the intermediate shaft 23, and the output shaft 22 are housed in the transmission case 24. The transmission case 24 also houses the first gear train G1 and the second gear train G2 provided on the input shaft 21, the intermediate shaft 23, and the output shaft 22, and the first clutch C1, the second clutch C2, and the brake B1.

As shown in FIG. 6, the oil pump 71, the relief valve 74, and the first and second solenoid valves 75 and 76 are attached to the transmission case 24, specifically, the bottom surface portion 26a of the lower case 26. An oil filter 73 is attached to the transmission case 24, specifically, a lower portion of the side surface portion 26b of the lower case 26. In the transmission unit 20, an oil pan 72 is formed by the bottom surface portion 26a and the side surface portion 26b of the lower case 26. The oil is stored in the oil pan 72 so that the first gear train G1 and the second gear train G2 are immersed in the oil.

The lower case 26 is provided with an oil suction port 26c and an oil supply passage 77 for supplying oil from the oil suction port 26c to the hydraulic chamber 55 of the first clutch C1 or the hydraulic chamber 65 of the second clutch C2 through the oil filter 73, the oil pump 71, the relief valve 74, the first solenoid valve 75, or the second solenoid valve 76. As shown in FIG. 4, the oil supply passage 77 is formed in the bottom surface portion 26a of the lower case 26, and is provided, in the transmission case 24, on the side opposite to the side where the motive power from the engine 10 is input to the input shaft 21. The oil supply passage 77 is branched from the relief valve 74 and includes an oil supply passage 78 to the hydraulic chamber 55 of the first clutch C1 and an oil supply passage 79 to the hydraulic chamber 65 of the second clutch C2.

The oil supply passage 78 to the hydraulic chamber 55 of the first clutch C1 includes a first oil passage 78a, a second oil passage 78b, and a third oil passage 78c. The first oil passage 78a extends from the output port b of the first solenoid valve 75 toward the output shaft 22. The second oil passage 78b communicates with the first oil passage 78a and extends in the shaft direction to the output shaft 22. The third oil passage 78c communicates with the second oil passage 78b and communicates with the hydraulic chamber 55 of the first clutch C1.

The oil supply passage 79 to the hydraulic chamber 65 of the second clutch C2 includes a first oil passage 79a, a second oil passage 79b, and a third oil passage 79c. The first oil passage 79a extends from the output port b of the second solenoid valve 76 toward the output shaft 22. The second oil passage 79b communicates with the first oil passage 79a and extends in the shaft direction to the output shaft 22. The third oil passage 79c communicates with the second oil passage 79b and communicates with the hydraulic chamber 65 of the second clutch C2.

In the transmission unit 20, since the hydraulic circuit 70 that supplies hydraulic pressure to the hydraulic chambers 55 and 65 of the first and second clutches C1 and C2 is formed in the transmission case 24, the transmission unit 20 can be integrated with the transmission case 24 with good assemblability.

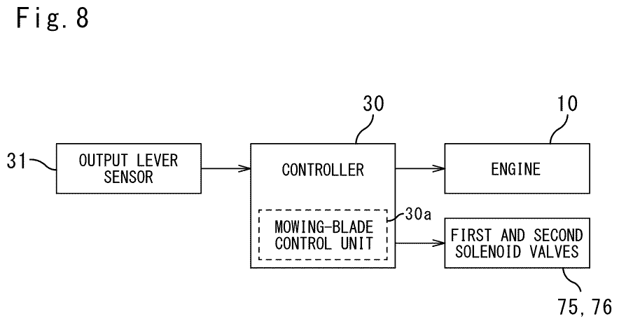

FIG. 8 is a control block diagram of a lawn mower. As shown in FIG. 8, the lawn mower 1 includes an output lever sensor 31. The output lever sensor 31 detects the position of the output lever 9. The output lever sensor 31 is connected to the controller 30 so as to be able to output a detection result to the controller 30. The controller 30 includes a computer that includes an arithmetic processing unit, a storage device, and the like.

The controller 30 functionally includes a mowing-blade control unit 30a by executing a predetermined program. When the output lever 9 is at the mowing-blade stop position after the engine is started, the engine 10 is set to a third rotation speed R3 at which the engine speed is lower than the second rotation speed R2. The lawn mower 1 is provided with a starting switch (not shown), and the controller 30 controls the engine 10 to start the engine 10 when the starting switch is turned on by the driver and to stop the engine 10 when the starting switch is turned off.

As a function of the mowing-blade control unit 30a, the controller 30 controls the engine 10 based on the output lever sensor 31, controls the first and second clutches C1 and C2, specifically, the first and second solenoid valves 75 and 76, and controls the mowing-blade 15.

In the lawn mower 1, when the output lever 9 switches the engine 10 between the first rotation speed R1 and the second rotation speed R2, the power transmission states of the first clutch C1 and the second clutch C2 are switched, whereby the output shaft 22 is rotationally driven at a substantially constant predetermined rotation speed. When the first and second clutches C1 and C2 bring the first and second gear trains G1 and G2 into the non-power transmission state, respectively, the brake B1 is fastened and the output shaft 22 is fixed to the transmission case 24.

The first rotation speed R1 and the second rotation speed R2 are set so that a mowing-blade rotation speed rotationally driven through the first gear train G1 when the engine speed is set to the first rotation speed R1 and a mowing-blade rotation speed rotationally driven through the second gear train G2 when the engine speed is set to the second rotation speed R2 become substantially constant predetermined rotation speeds. In the lawn mower 1, when the first rotation speed is set to 3600 rpm and the second rotation speed is set to 2600 rpm, the mowing-blade rotation speed is set to approximately 3600 rpm but is not limited thereto. The third rotation speed R3 is set to 1500 rpm but is not limited thereto.

The controller 30 controls the engine 10 so as to reach the first rotation speed R1 at the high engine output position of the output lever 9, and controls the first and second solenoid valves 75 and 76 so as to fasten the first clutch C1 and release the second clutch C2. The controller 30 controls the engine 10 so as to reach the second rotation speed at the low engine output position of the output lever 9, and controls the first and second solenoid valves 75 and 76 so as to fasten the second clutch C2 and release the first clutch C1. The controller 30 controls the engine 10 to reach the third rotation speed R3 at the mowing-blade stop position of the output lever 9, and controls the first and second solenoid valves 75 and 76 so as to release the first clutch C1 and the second clutch C2 and fasten the brake B1. In the present embodiment, when the input signals to the first and second solenoid valves 75 and 76 are off, that is, when the first and second solenoid valves 75 and 76 are de-energized, the hydraulic pressure of the first and second clutches C1 and C2 is discharged to fasten the brake B1, and the output shaft 22 is safely stopped.

At the time of mowing work, the controller 30 reads various signals from a sensor or the like and controls the mowing-blade. In the mowing-blade control, the engine is controlled to set the engine speed to the first rotation speed R1 or the second rotation speed R2 based on the operation command of the output lever 9, and the first clutch G1 and the second clutch G2 are controlled to bring the first gear train G1 or the second gear train G2 into the power transmission state, and the mowing-blade 15 is rotated at a predetermined rotation speed.

The thus-configured lawn mower 1 includes an engine 10, a mowing-blade 15 rotationally driven by the motive power from the engine 10, and a transmission unit 20 that shifts the motive power from the engine 10 and outputs the motive power to the mowing-blade 15. In the transmission unit 20, when the engine 10 is switched between the first rotation speed R1 and the second rotation speed R2 lower than the first rotation speed R1, the power transmission states of the first clutch C1 and the second clutch C2 are switched, so that the output shaft 22 is rotationally driven at a predetermined rotation speed.

In the lawn mower 1, the engine speed is set to the first rotation speed R1 or the second rotation speed R2 which is lower than the first rotation speed R1 by the output lever 9. However, a mowing load may be detected, and the engine speed may be set to the first rotation speed R1 or the second rotation speed R2 which is lower than the first rotation speed R1 according to the mowing load by the mowing-blade 15.

For example, the lawn mower 1 may include a load torque sensor that detects a load torque applied to the mowing-blade 15, and the controller 30 may set the engine speed to the first rotation speed R1 when the load torque detected by the load torque sensor is a predetermined value or more, and set the engine speed to the second rotation speed R2 that is lower than the first rotation speed R1 when the load torque detected by the load torque sensor is less than the predetermined value.

Also in this case, the controller 30 performs control to fasten the first clutch C1 and release the second clutch C2 when controlling the engine speed to the first rotation speed R1, and performs control to fasten the second clutch C2 and release the first clutch C1 when controlling the engine speed to the second rotation speed R2.

The transmission unit 20 includes the input shaft 21, the output shaft 22, and the intermediate shaft 23. However, without including the intermediate shaft 23, the first gear train G1 may be formed by the first drive gear provided on the input shaft 21 and the first driven gear provided on the output shaft 22, the second gear train G2 may be formed by the second drive gear provided on the input shaft 21 and the second driven gear provided on the output shaft 22, and the reduction ratio of the second gear train G2 may be set smaller than that of the first gear train G1.

Also in this case, the first clutch C1 and the second clutch C2 are configured to switch the first gear train G1 and the second gear train G2 to the power transmission state or the non-power transmission state, respectively. When the engine 10 is switched between the first rotation speed R1 and the second rotation speed R2 that is lower than the first rotation speed R1, the output shaft of the transmission unit is rotationally driven at a predetermined rotation speed by switching the power transmission state of the first clutch C1 and the second clutch C2.

In the lawn mower 1, the first rotation speed R1 and the second rotation speed R2 of the engine 10, and the reduction ratios of the first gear train G1 and the second gear train G2 of the transmission unit 20 are set so that the rotation speed of the output shaft 22 of the transmission unit 20, and eventually the rotation speed of the mowing-blade 15, becomes a substantially constant predetermined rotation speed.

The lawn mower 1 may include a power take-off (PTO) switch for extracting motive power from the engine 10 for the mowing-blade. The mowing-blade control of the lawn mower 1 may control the connection state of first clutch G1 and second clutch G2 based on the operation command of the output lever 9 and the ON/OFF signal of the PTO switch. The lawn mower 1 has a brake B1, but may not have the brake B1. Although the engine 10 is used as the traveling drive source and the mowing-blade drive source, separate drive sources may be used as the traveling drive source and the mowing-blade drive source. Although the transmission unit 20 is mounted on the lawn mower 1, it may be mounted on a work machine such as another farm work machine. The transmission unit 20 uses the engine 10 as a drive source, but may use another drive source.

As described above, the transmission unit 20 according to the present embodiment includes the input shaft 21 to which the motive power from the drive source 10 is input, the output shaft 22 that outputs the motive power from the drive source 10, the first gear train G1 and the second gear train G2 provided between the input shaft 21 and the output shaft 22, the first clutch C1 and the second clutch C2 that respectively switch the first gear train G1 and the second gear train G2 to the power transmission state or the non-power transmission state, and the transmission case 24 that houses the input shaft 21, the output shaft 22, the first gear train G1, the second gear train G2, the first clutch C1, and the second clutch C2. When the drive source 10 is switched between the first rotation speed R1 and the second rotation speed R2 lower than the first rotation speed R1, the power transmission states of the first clutch C1 and the second clutch C2 are switched, so that the output shaft 22 is rotationally driven at a predetermined rotation speed. Each of the first clutch C1 and the second clutch C2 is a hydraulic clutch, and the hydraulic circuit 70 that supplies hydraulic pressure to the hydraulic chambers 55 and 65 of the first clutch C1 and the second clutch C2 is formed in the transmission case 24.

In the transmission unit 20, even when the drive source 10 is switched between the first rotation speed R1 and the second rotation speed R2, the output shaft 22 is rotationally driven at a predetermined rotation speed by switching the power transmission state of the first clutch C1 and the second clutch C2. Accordingly, even when the drive source 10 is rotationally driven at the second rotation speed R2 that is lower than the first rotation speed R1, the output shaft 22 can be rotationally driven at the predetermined rotation speed, and fuel consumption can be suppressed while securing output performance. In the transmission unit 20, since the hydraulic circuit 70 that supplies hydraulic pressure to the hydraulic chambers 55 and 65 of the first clutch C1 and the second clutch C2 is formed in the transmission case 24, the transmission unit 20 can be integrated with the transmission case 24 with good assemblability. Therefore, the transmission unit 20 can suppress the fuel consumption while securing the output performance, and can be integrated with the transmission case 24 with good assemblability.

In addition, the input shaft 21 and the output shaft 22 can extend in the vertical direction. Accordingly, by arranging the output shaft 11 of the drive source 10 so as to extend in the vertical direction, when motive power is output from the output shaft 22 to the mowing-blade 15, the positions of the rotation shaft 16 of the mowing-blade 15 arranged in the vertical direction, the output shaft 11 of the drive source 10, and the input shaft 21 and the output shaft 22 of the transmission unit 20 can be matched, and the rotation direction of the motive power from the drive source 10 can be transmitted without any change.

In addition, the hydraulic circuit 70 may include an oil supply passage 77 that supplies hydraulic pressure to the first clutch C1 and the second clutch C2, and the oil supply passage 77 may be provided on the side opposite to the side where motive power from the drive source 10 is input to the input shaft 21 in the transmission case 24. Accordingly, when the drive source 10 is disposed above the transmission unit 20, the oil supply passage 77 can be provided below the transmission case 24, and the oil supply passage 77 can be shortened.

In addition, a brake B1 may be included that fixes the output shaft 22 when the first clutch C1 and the second clutch C2 respectively bring the first gear train G1 and the second gear train G2 into the non-power transmission state. Accordingly, the output shaft 22 can be prevented from rotating when the first gear train G1 and the second gear train G2 are in the non-power transmission state.

In addition, an intermediate shaft 23 disposed in parallel with the input shaft 21 and the output shaft 22 may be included. The input shaft 21 may be provided with a drive gear 41. The first gear train G1 may include a first driven gear 42 provided on the output shaft 22 and a first intermediate gear 44 provided on the intermediate shaft 23 and meshing with the drive gear 41 and the first driven gear 42. The second gear train G2 may include a second driven gear 43 provided on the output shaft 22 and a second intermediate gear 45 provided on the intermediate shaft 23 and meshing with the second driven gear 43. In a transmission unit capable of rotating the input shaft 21 and the output shaft 22 in the same direction, it is possible to suppress fuel consumption while securing output performance and to be integrated with the transmission case 24 with good assemblability.

In addition, the input shaft 21, the intermediate shaft 23, and the output shaft 22 may extend in a vertical direction. The first gear train G1 may be disposed above the second gear train G2. Accordingly, when the drive source 10 is disposed above the transmission unit 20, by disposing the first gear train G1 having the first intermediate gear 44 meshing with the drive gear 41 above the second gear train G2, the size on the opposite side of the drive source of the transmission unit 20 can be made smaller than the size on the side of the drive source, and the space on the lower side of the transmission unit 20 can be effectively used, for example, by disposing the oil pump 71.

In addition, the hydraulic circuit 70 may include hydraulic control valves 75 and 76 that control hydraulic pressure supplied to the first clutch C1 and the second clutch C2, and an oil pump 71 that is driven by the drive source 10 to generate hydraulic pressure. The hydraulic control valves 75 and 76 and the oil pump 71 may be disposed in the transmission case 24. Accordingly, the hydraulic control valves 75 and 76 and the oil pump 71 can be disposed in the transmission case 24, and the transmission unit 20 can be configured to be compact as compared with the case of being disposed outside the transmission case 24.

In addition, a lawn mower 1 according to the present embodiment includes: a drive source 10; a mowing-blade 15 rotationally driven by motive power from the drive source 10; and the transmission unit 20 configured to shift motive power from the drive source 10 and outputs the motive power to the mowing-blade 15. The transmission unit 20 includes the input shaft 21 to which the motive power from the drive source 10 is input, the output shaft 22 that outputs the motive power from the drive source 10, the first gear train G1 and the second gear train G2 provided between the input shaft 21 and the output shaft 22, the first clutch C1 and the second clutch C2 that respectively switch the first gear train G1 and the second gear train G2 to the power transmission state or the non-power transmission state, and the transmission case 24 that houses the input shaft 21, the output shaft 22, the first gear train G1, the second gear train G2, the first clutch C1, and the second clutch C2. When the drive source 10 is switched between the first rotation speed R1 and the second rotation speed R2 lower than the first rotation speed R1, the power transmission states of the first clutch C1 and the second clutch C2 are switched, so that the output shaft 22 is rotationally driven at a predetermined rotation speed. Each of the first clutch C1 and the second clutch C2 is a hydraulic clutch, and the hydraulic circuit 70 that supplies hydraulic pressure to the hydraulic chambers 55 and 65 of the first clutch C1 and the second clutch C2 is formed in the transmission case 24.

In the lawn mower 1 including the drive source 10, the mowing-blade 15, and the transmission unit 20, the transmission unit 20 that can be integrated with the transmission case 24 with good assemblability is disposed between the drive source 10 and the mowing-blade 15, and when a load on the mowing-blade 15 rotationally driven by the drive source 10 is small, even when the drive source 10 is rotationally driven at the second rotation speed lower than the first rotation speed, the mowing-blade 15 can be rotationally driven at a predetermined rotation speed, and it is possible to suppress fuel consumption while securing lawn mowing quality.

The present disclosure is not limited to the illustrated embodiments, and various improvements and design changes can be made without departing from the gist of the present disclosure.

What is claimed is:

1. A transmission unit comprising:
an input shaft to which motive power from a drive source is input;
an output shaft configured to output the motive power from the drive source;
a first gear train and a second gear train provided between the input shaft and the output shaft;
a first clutch and a second clutch configured to respectively switch the first gear train and the second gear train to a power transmission state or a non-power transmission state; and
a transmission case configured to house the input shaft, the output shaft, the first gear train, the second gear train, the first clutch, and the second clutch,
wherein when the drive source is switched between a first rotation speed and a second rotation speed lower than the first rotation speed, the power transmission states of the first clutch and the second clutch are switched, so that the output shaft is rotationally driven at a predetermined rotation speed,
wherein each of the first clutch and the second clutch is a hydraulic clutch, and
wherein a hydraulic circuit that supplies hydraulic pressure to hydraulic chambers of the first clutch and the second clutch is formed in a transmission case.

2. The transmission unit according to claim 1, wherein the input shaft and the output shaft extend in a vertical direction.

3. The transmission unit according to claim 1,
wherein the hydraulic circuit includes an oil supply passage that supplies hydraulic pressure to the first clutch and the second clutch, and
wherein the oil supply passage is provided on a side opposite to a side on which the motive power from the drive source is input to the input shaft in the transmission case.

4. The transmission unit according to claim 1, further comprising a brake that fixes the output shaft when the first clutch and the second clutch respectively bring the first gear train and the second gear train into the non-power transmission state.

5. The transmission unit according to claim 1,
further comprising an intermediate shaft disposed in parallel with the input shaft and the output shaft,
wherein the input shaft is provided with a drive gear,
wherein the first gear train includes a first driven gear provided on the output shaft and a first intermediate gear provided on the intermediate shaft and meshing with the drive gear and the first driven gear, and
wherein the second gear train includes a second driven gear provided on the output shaft and a second intermediate gear provided on the intermediate shaft and meshing with the second driven gear.

6. The transmission unit according to claim 5,
wherein the input shaft, the intermediate shaft, and the output shaft extend in a vertical direction, and
wherein the first gear train is disposed above the second gear train.

7. The transmission unit according to claim 1,
wherein the hydraulic circuit includes a hydraulic control valve that controls hydraulic pressure supplied to the first clutch and the second clutch, and an oil pump that is driven by the drive source to generate hydraulic pressure, and
wherein the hydraulic control valve and the oil pump are disposed in the transmission case.

8. A lawn mower comprising:
a drive source;
a mowing-blade rotationally driven by motive power from the drive source; and
the transmission unit according to claim 1 configured to shift motive power from the drive source and output the motive power to the mowing-blade.
